(19) United States
(12) Patent Application Publication
(10) Pub. No.: US 2008/0073950 A1
(43) Pub. Date: Mar. 27, 2008

(54) Locking structure of an active headrest

(76) Inventor: Hyun Ko, Ansan-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/636,698

(22) Filed: Dec. 8, 2006

(30) Foreign Application Priority Data
Aug. 10, 2006 (KR) 10-2006-0075706

(51) Int. Cl. B60N 2/42

(52) U.S. Cl. 297/216.12

(57) ABSTRACT

An active headrest with a locking structure includes an active headrest frame positioned at an inner frontal surface of a seatback frame, an armature supporting the active headrest, optionally a suspension installed below the armature, a frame supporting member installed at an inner frontal surface of the seatback frame, the frame supporting member defining a receiving hole for receiving and supporting the armature, and a locking apparatus. The locking apparatus may include a locking plate, preferably having a triangular shape, rotatably connected to a fixing hinge, and an elastic member, preferably a spring, having a restoring force coupled to the fixing hinge, a through hole defined by the armature. During operation the armature rises exposing the through hole and the locking plate is extruded through the through hole by the force of the elastic member.

### CROSS-REFERENCE TO RELATED APPLICATION

This application claims priority to and the benefit of Korean Patent Application No. 10-2006-0075706 filed in the Korean Intellectual Property Office on Aug. 10, 2006, the entire contents of which are incorporated herein by reference.

### BACKGROUND OF THE INVENTION

(a) Field of the Invention

The present invention relates to a locking structure of an active headrest for a vehicle, and more particularly to a locking structure of an active headrest provided with a locking apparatus capable of maintaining a position of the active headrest after operation thereof.

(b) Description of the Related Art

An active headrest is used in order to protect a passenger. An active headrest automatically rises in response to a vehicle crash, thereby protecting the head and the neck part of the passenger. Generally, the active headrest automatically operates if a vehicle accident is detected.

In the conventional rotating hinge-type active headrest, after the operation of an active headrest, the operated state of the active headrest cannot be continuously maintained. Thus, the active headrest returns to its original position by a restoring force of a hinge spring. Accordingly, the conventional active headrest does not continuously support the head of a passenger, which increases the likelihood of passenger injury.

Another conventional active headrest is an actuator-type headrest. In the case of an actuator-type active headrest, an actuator causes the headrest to continuously support the head of a passenger after operation. However, applying a locking apparatus used in the actuator-type active headrest to the rotating hinge-type active headrest creates various design difficulties. For example, manufacturing costs increase. Also, the rotating hinge-type active headrest cannot be separated, so convenience of installation and replacement is deteriorated. Furthermore, in a current EURO-NPCA test, an incentive is endowed to a vehicle provided with an active headrest, so development of a locking structure of an active headrest is needed.

### SUMMARY OF THE INVENTION

Embodiment of the present invention provides a locking structure of an active headrest by means of a locking apparatus. The locking apparatus maintains the operated, or post activation, position of an active headrest. The maintenance of the operated position continuously supports the head of a passenger during an accident, thereby reducing the likelihood of passenger injury. In addition, the present invention provides a locking apparatus that can be simply installed, thereby reducing a manufacturing cost.

Embodiments of the present invention may include an active headrest with a locking structure comprising: an active headrest frame positioned at an inner frontal surface of a seatback frame, an armature supporting the active headrest, optionally a suspension installed below the armature, a frame supporting member installed at an inner frontal surface of the seatback frame, the frame supporting member defining a receiving hole for receiving and supporting the armature, and a locking apparatus comprising: a locking plate, preferably having a triangular shape, rotatably connected to a fixing hinge, and an elastic member, preferably a spring, having a restoring force coupled to the fixing hinge, a through hole defined by the armature.

During operation the armature rises exposing the through hole and the locking plate is extruded through the through hole by the force of the elastic member. A bushing for supporting the locking plate in an operated state may be installed between an inside of the receiving hole and an outer circumferential surface of the armature. A pushing protrusion may be formed at a side of the locking plate and contacts an end portion of the elastic member so as to be pushed by the restoring force during the operation, thereby extruding a portion of the locking plate outside the through hole.

### BRIEF DESCRIPTION OF THE DRAWINGS

FIG. 1 is a perspective view of an embodiment of an active headrest in a state before operation.

FIG. 2 is a perspective view of an embodiment of a locking apparatus of an active headrest in a state before operation.

FIG. 3 is a perspective view of an embodiment of an active headrest in the operating state.

FIG. 4 is a perspective view of an embodiment of a locking apparatus of an active headrest in the operating state.

FIG. 5 is a cross sectional view of an embodiment of a locking apparatus in a state before operation.

FIG. 6 is a cross sectional view of an embodiment of a locking apparatus in the operating state.

### DETAILED DESCRIPTION OF THE EMBODIMENTS

Various embodiments of the present invention will hereinafter be described in detail with reference to accompanying drawings. However other embodiments are also possible.

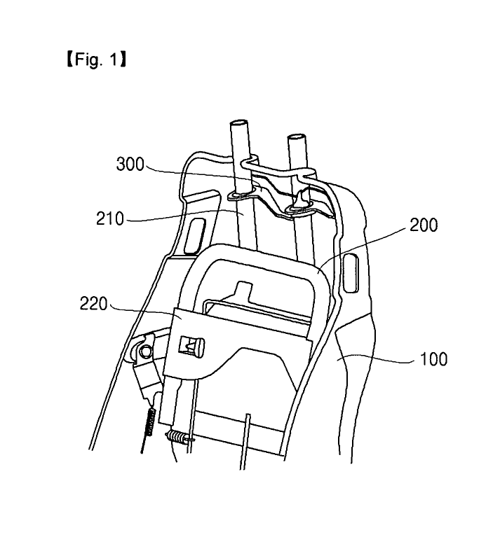

FIG. 1 is an embodiment of an active headrest with a locking structure in a state before operation which includes a seat back frame 100 forming framework of a vehicular seat back, an active headrest frame 200 provided with an armature 210 supporting an active headrest (not shown) and installed inside the seat back frame 100, a frame supporting member 300 mounted to the seat back frame 100 and supporting the armature 210. The armature 210 supporting the active headrest is mounted to an upper portion of the active headrest frame 200, and a suspension 220 is mounted to a lower portion of the active headrest frame 200.

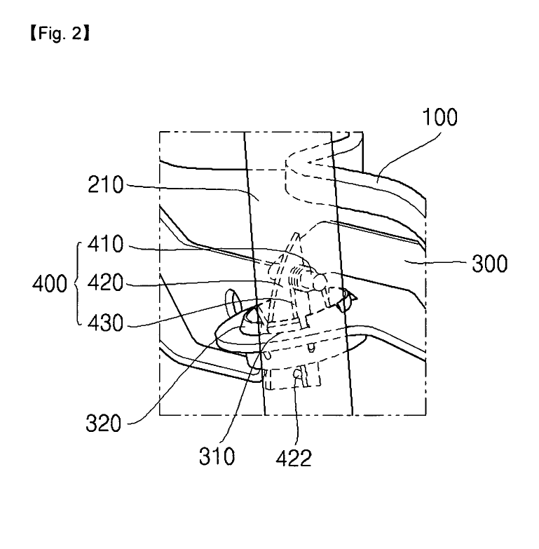

FIG. 2 is a perspective view of an embodiment of a locking apparatus of an active headrest in a state before operation. As shown in FIG. 2, the frame supporting member 300 is attached to an upper portion of the seat back frame 100, and a receiving hole 310 for receiving the armature 210 so as to support the same is formed in the frame supporting member 300. The locking apparatus 400 is installed inside the armature 210, and includes a fixing hinge 410, the locking plate 420 rotatably connected to the fixing hinge 410, and an elastic member 430 connected to the fixing hinge 410 so as to elastically support the locking plate 420. The elastic member 430 is coupled to the fixing hinge 410, and may be preferably realized as a spring. The fixing hinge 410 is fixed inside the armature 210 so as to rotatably support the locking plate 420. The locking plate 420 has a triangular shape one edge of which is formed as a streamline, and a center region of an upper portion thereof is rotatably connected to the fixing hinge 410. A bushing 320 is fitted into the receiving hole 310 of the frame supporting member 300, so as to support the locking plate 420 of the locking apparatus 400, thereby reducing abrasions of the frame supporting member 300 and the locking plate 420. A pushing protrusion 422 formed at a side of the locking plate 420 contacts one end of the elastic member 430. It is preferable that the pushing protrusion 422 is located behind the center of a lower surface of the locking plate 420 such that the locking plate 420 can be pushed by restoring force of the elastic member 430. An edge of the locking plate 420 is pushed by an inner surface of the armature 210 in the case that the active headrest does not operate, so that the pushing protrusion 422 compresses the elastic member 430.

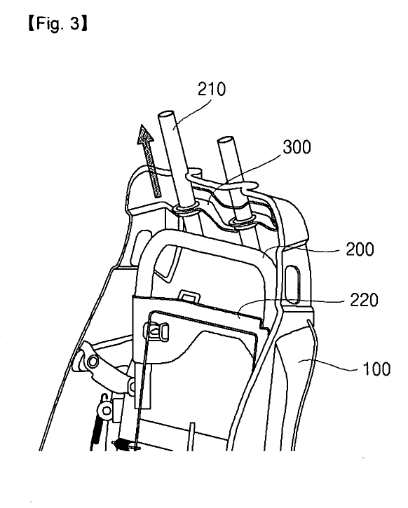

FIG. 3 is an embodiment of an active headrest with a locking structure in the operating state which includes a seat back frame 100 forming framework of a vehicular seat back, an active headrest frame 200 provided with an armature 210 supporting an active headrest (not shown) and installed inside the seat back frame 100, a frame supporting member 300 mounted to the seat back frame 100 and supporting the armature 210. The armature 210 supporting the active headrest is mounted to an upper portion of the active headrest frame 200, and a suspension 220 is mounted to a lower portion of the active headrest frame 200. When the active headrest operates, the headrest (not shown) and the armature 210 rise.

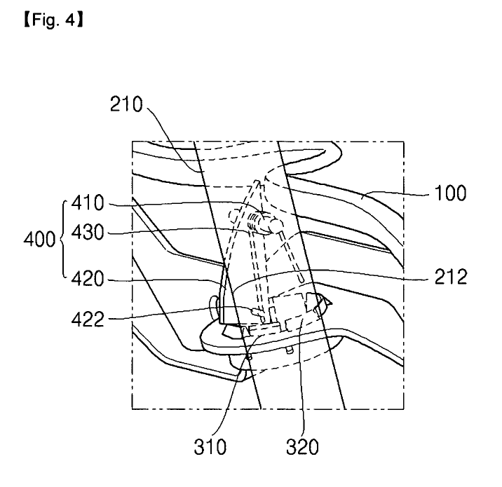

FIG. 4 is a perspective view of an embodiment of a locking apparatus of an active headrest in the operating state. As shown in FIG. 4, the frame supporting member 300 (not labeled) is attached to an upper portion of the seat back frame 100, and a receiving hole 310 for receiving the armature 210 so as to support the same is formed in the frame supporting member 300. The locking apparatus 400 is installed inside the armature 210, and includes a fixing hinge 410, the locking plate 420 rotatably connected to the fixing hinge 410, and an elastic member 430 connected to the fixing hinge 410 so as to elastically support the locking plate 420. The elastic member 430 is coupled to the fixing hinge 410, and may be preferably realized as a spring. The fixing hinge 410 is fixed inside the armature 210 so as to rotatably support the locking plate 420. The locking plate 420 has a triangular shape one edge of which is formed as a streamline, and a center region of an upper portion thereof is rotatably connected to the fixing hinge 410. A bushing 320 is fitted into the receiving hole 310 of the frame supporting member 300, so as to support the locking plate 420 of the locking apparatus 400, thereby reducing abrasions of the frame supporting member 300 and the locking plate 420. A through hole 212 is formed in an outer circumferential surface of the armature 210. In this case, the through hole 212 is perforated at a front portion of the armature 210. The through hole 212 may be preferably formed at a position in which a locking plate 420 of the locking apparatus 400 is exposed only during the operation of the active headrest. A pushing protrusion 422 contacting one end of the elastic member 430 is protruded at a lower side surface of the locking plate 420.

When the active headrest operates, the armature 210 rises so as to expose the through hole 212. A lower portion of the streamlined edge of the locking plate 420 is partially extruded through the through hole 212 formed in the armature 210 and is maintained to be hooked by the bushing 320 so that the position of the active headrest after the operation of the active headrest remains constant. Accordingly, the pushing protrusion 422 is pushed toward the outside the armature 210 by the restoring force of the elastic member 430. Since one end portion of the elastic member 430 presses the pushing protrusion 422 so that the locking plate 420 is exposed through the through hole 212, it is preferable that the elastic member 430 is installed such that the restoring force thereof acts toward the through hole 212. By the above-mentioned structure, the locking apparatus 400 is received within the through hole 212 of the armature 210, and operates so as to fix the position of the active headrest.

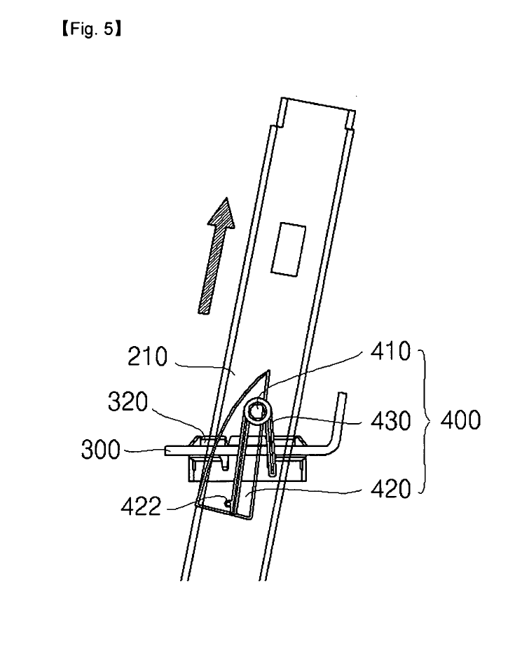

FIG. 5 is a cross sectional view of an embodiment of a locking apparatus in a state before operation. As shown in FIG. 5, when the active headrest is in a state before operation, the through hole 212 (not labeled) formed in the armature 210 is closed by the bushing 320 of the frame supporting member 300. Accordingly, the locking apparatus 400 including the locking plate 420, elastic member 430, and fixing hinge 410, are installed inside the armature 210. The pushing protrusion 422 installed inside the armature 210 is received within the armature 210 while compressing the elastic member 430.

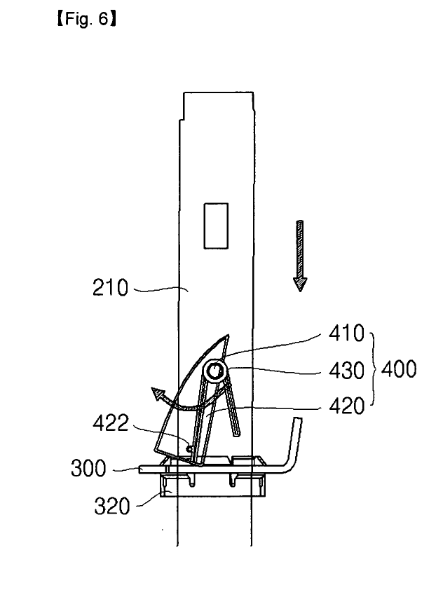

FIG. 6 is a cross sectional view of an embodiment of a locking apparatus in the operating state. When the active headrest operates, the armature 210 rises. This activates the locking apparatus 400 including the locking plate 420, elastic member 430, and fixing hinge 410 in the following way. The pushing protrusion 422 is pushed toward the outside of the armature 210 by the restoring force of the elastic member 430. Accordingly, the locking plate 420 is hooked by the bushing 320 while one edge of the locking plate 420 is partially exposed outside the through hole 212 (not labeled). Since the locking plate 420 is extruded and is maintained to be hooked by the bushing 320 of the frame supporting member 300, the active headrest will not returning to its original position.

While the foregoing description and drawing represent various embodiments of the present invention, it should be appreciated that the foregoing description should not be deemed limiting since additions, variations, modification, and substitutions may be made without departing from the spirit and scope of the present invention. It will be clear to one of skill in the art that the present invention may be embodied in other forms, structures, arrangements, proportions and using other elements, materials and components.

What is claimed is:

1. A locking structure of an active headrest, comprising:
a locking apparatus installed inside an armature of a seatback frame,
said locking apparatus comprising:
a locking plate rotatably connected to a fixing hinge, and an elastic member having a restoring force coupled to said fixing hinge, a through hole defined by said armature, wherein during operation said armature rises exposing said through hole and said locking plate is extruded through said through hole by said force of said elastic member.

2. The locking structure of claim 1, wherein said elastic member is a spring.

3. The locking structure of claim 1, wherein said locking plate has a triangular shape.

4. The locking structure of claim 1, wherein a pushing protrusion is formed at a side of said locking plate and contacts an end portion of said elastic member so as to be pushed by said restoring force during the operation thereby extruding said locking plate outside said through hole.

5. An active headrest with a locking structure comprising:
an active headrest frame positioned at an inner frontal surface of a seatback frame, an armature supporting said active headrest, a frame supporting member installed at an inner frontal surface of said seatback frame, said frame supporting member defining a receiving hole for receiving and supporting said armature, and a locking apparatus comprising:
a locking plate rotatably connected to a fixing hinge, and an elastic member having a restoring force coupled to said fixing hinge, a through hole defined by said armature, wherein during operation said armature rises exposing said through hole and said locking plate is extruded through said through hole by said force of said elastic member.

6. An active headrest with a locking structure of claim 5, further comprising a suspension installed below said armature.

7. An active headrest with a locking structure of claim 5, further comprising a bushing for supporting said locking plate in an operated state is installed between an inside of the receiving hole and an outer circumferential surface of said armature.

8. The locking structure of claim 5, wherein said elastic member is a spring.

9. The locking structure of claim 5, wherein said locking plate has a triangular shape.

10. The locking structure of claim 5, wherein a pushing protrusion is formed at a side of said locking plate and contacts an end portion of said elastic member so as to be pushed by said restoring force during the operation thereby extruding a portion of said locking plate outside said through hole.
